(19) United States
(12) Patent Application Publication
(10) Pub. No.: US 2025/0236109 A1
(43) Pub. Date: Jul. 24, 2025

(54) INKJET CONTROL METHOD AND INKJET RECORDING APPARATUS

(71) Applicant: KYOCERA Document Solutions Inc., Osaka (JP)

(72) Inventor: Masayuki Miyake, Osaka (JP)

(21) Appl. No.: 19/016,852

(22) Filed: Jan. 10, 2025

(30) Foreign Application Priority Data
Jan. 19, 2024 (JP) 2024-006562

(51) Int. Cl. B41J 2/165; B41J 13/08; B41J 29/00

(52) U.S. Cl. CPC B41J 2/1652; B41J 13/08; B41J 29/00; B41J 2002/16573

(57) ABSTRACT

A processor acquires sheet length information representing a length in a conveying direction of a target sheet to be conveyed by a belt conveyor device. The processor selects one or both of a first flushing process and a second flushing process as a target flushing process in accordance with the sheet length information, and causes a nozzle unit to execute the target flushing process. The first flushing process is a process of ejecting ink toward each of a plurality of opening portions in an area of a conveying belt where no sheet exists. The second flushing process is a process of ejecting ink onto a non-drawing area of the target sheet in parallel with a printing process on the target sheet.

### INCORPORATION BY REFERENCE

This application is based upon and claims the benefit of priority from the corresponding Japanese Patent Application No. 2024-006562 filed on Jan. 19, 2024, the entire contents of which are incorporated herein by reference.

### BACKGROUND

The present disclosure relates to an inkjet control method and an inkjet recording apparatus for performing flushing control for preventing nozzle clogging.

The inkjet recording apparatus executes a printing process of forming an image on a sheet using an inkjet method. In the inkjet recording apparatus, it is necessary to prevent clogging of each of a plurality of nozzles. For example, it is known that flushing control is performed when a predetermined time has elapsed since the last printing process.

The flushing control is control for causing the inkjet recording apparatus to execute a flushing process of ejecting ink independently of the printing process. For example, the flushing control is executed under a condition where the plurality of nozzles are covered with caps.

### SUMMARY

An image formation control method according to one aspect of the present disclosure is a method for controlling an inkjet recording apparatus including a belt conveyor device and a nozzle unit. The belt conveyor device includes an endless conveying belt in which a plurality of opening portions, each including one or more through holes, are formed at intervals in a circumferential direction and conveys a sheet on the conveying belt by rotating the conveying belt. The nozzle unit includes a plurality of nozzles disposed to face an upper surface of the conveying belt and a plurality of piezoelectric elements configured to cause the plurality of nozzles to eject ink by pressurizing the ink supplied to the plurality of nozzles, and is capable of executing a printing process. The printing process is a process of forming an image on the sheet by ejecting ink onto the sheet conveyed on the conveying belt. The inkjet control method includes the processor acquiring sheet length information representing a length in a conveying direction of a target sheet to be conveyed by the belt conveyor device. The inkjet control method further includes the processor selecting one or both of a first flushing process and a second flushing process as a target flushing process in accordance with the sheet length information, and causing the nozzle unit to execute the target flushing process. The first flushing process is a process of ejecting ink toward each of the plurality of opening portions in an area of the conveying belt where the sheet does not exist. The second flushing process is a process of ejecting ink toward a non-drawing area of the target sheet in parallel with the printing process on the target sheet.

An inkjet recording apparatus according to another aspect of the present disclosure includes the belt conveyor device, the nozzle unit, and the processor configured to implement the inkjet control method.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a configuration diagram of an inkjet recording apparatus according to an embodiment.

FIG. 2 is a cross-sectional view of an ink ejection portion of a nozzle unit in the inkjet recording apparatus according to the embodiment.

FIG. 3 is a block diagram showing a configuration of a control device in the inkjet recording apparatus according to the embodiment.

FIG. 4 is a plan view of a belt conveyor device in the inkjet recording apparatus according to the embodiment.

FIG. 5 is a flowchart showing an example of the procedure of flushing control in the inkjet recording apparatus according to the embodiment.

FIG. 6 is a plan view of the belt conveyor device conveying sheets of a standard length.

FIG. 7 is a plan view of the belt conveyor device conveying a sheet longer than the standard length.

FIG. 8 is a flowchart showing a modification of the procedure of the flushing control in the inkjet recording apparatus according to the embodiment.

### DETAILED DESCRIPTION

Hereinafter, an embodiment of the present disclosure will be described with reference to the drawings. It is noted that the following embodiment is an example of embodying the present disclosure and does not limit the technical scope of the present disclosure.

### [Configuration of Inkjet Recording Apparatus 10]

An inkjet recording apparatus 10 according to the embodiment is a printer capable of executing a printing process using an inkjet method.

The printing process is a process of forming an image on a sheet 9 by ejecting ink onto the sheet 9. The sheet 9 is a sheet-like image forming medium such as paper or a resin film.

It is noted that the inkjet recording apparatus 10 may be a facsimile machine, a copier, a multifunction peripheral, or the like capable of executing the printing process using an inkjet method.

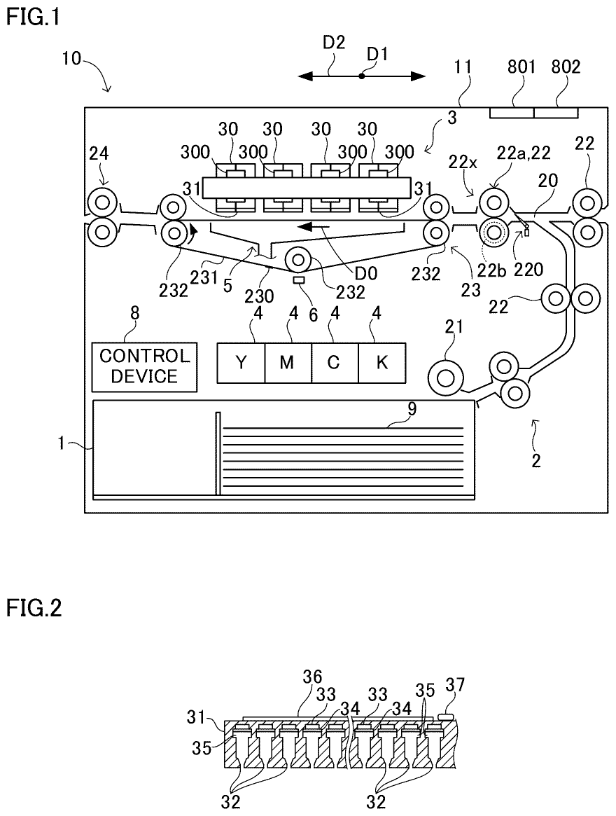

As shown in FIG. 1, the inkjet recording apparatus 10 includes a sheet storing portion 1, a sheet conveying device 2, a printing portion 3, a plurality of ink supply portions 4, a control device 8, and the like.

The sheet storing portion 1, the sheet conveying device 2, the printing portion 3, the plurality of ink supply portions 4, and the control device 8 are disposed in a main housing 11. The inkjet recording apparatus 10 further includes an operation device 801 and a display device 802.

The sheet conveying device 2 feeds sheets 9 stored in the sheet storing portion 1 one by one to a conveying path 20, and further conveys each sheet 9 along the conveying path 20.

The sheet conveying device 2 includes a feeding mechanism 21, a plurality of conveying roller pairs 22, a belt conveyor device 23, a discharge roller pair 24, and the like. The feeding mechanism 21 feeds the sheet 9 from the sheet storing portion 1 to the conveying path 20. The plurality of conveying roller pairs 22 convey the sheet 9 along the conveying path 20, and further convey the sheet 9 to the belt conveyor device 23.

The plurality of conveying roller pairs 22 may convey a cut sheet supplied from a roll sheet supply device connected at a preceding stage of the inkjet recording apparatus 10 to the belt conveyor device 23. The roll sheet supply device rolls out a roll sheet that is rolled and cuts the rolled-out sheet at a preset length to produce a cut sheet. Further, the roll sheet supply device supplies the cut sheet to the inkjet recording apparatus 10. The cut sheet is an example of the sheet 9.

The belt conveyor device 23 is disposed below the printing portion 3. The belt conveyor device 23 includes an endless conveying belt 231 and a plurality of tension rollers 232.

The plurality of tension rollers 232 rotatably support the conveying belt 231. A motor (not shown) rotates one of the plurality of tension rollers 232 to rotate the conveying belt 231. The belt conveyor device 23 rotates the conveying belt 231 to convey the sheet 9 on the conveying belt 231 in a conveying direction DO.

The direction orthogonal to the conveying direction DO is a main scanning direction D1, and the direction along the conveying direction DO is a sub-scanning direction D2 (see FIG. 1).

The plurality of conveying roller pairs 22 include a registration roller pair 22a disposed at the preceding stage of the belt conveyor device 23. The registration roller pair 22a is disposed upstream of the belt conveyor device 23 in the conveying direction DO.

The sheet conveying device 2 includes a registration motor 22b for rotating the registration roller pair 22a, and a sheet detection device 220 disposed at the preceding stage of the registration roller pair 22a.

The registration roller pair 22a and the registration motor 22b constitute a preceding conveying device 22x for conveying the sheet 9 to the belt conveyor device 23. The sheet detection device 220 detects the sheet 9 at a position upstream of the registration roller pair 22a in the conveying direction DO on the conveying path 20.

The preceding conveying device 22x can convey the sheet 9 to the belt conveyor device 23 at any timing after temporarily stopping the conveyance of the sheet 9 in accordance with the detection timing of the sheet 9 by the sheet detection device 220.

The printing portion 3 ejects inks of a plurality of colors toward the sheet 9 conveyed by the belt conveyor device 23, thereby forming an image on the sheet 9.

The discharge roller pair 24 is disposed downstream of the belt conveyor device 23 in the conveying direction DO. The discharge roller pair 24 discharges the sheet 9 on which the image has been formed to the outside of the main housing 11. For example, the discharge roller pair 24 feeds the sheet 9 from the main housing 11 to a discharge tray or a post-stage device disposed next to the inkjet recording apparatus 10.

Each of the plurality of ink supply portions 4 supplies ink of a predetermined color to the printing portion 3. For example, the colors of the inks are black, cyan, magenta, and yellow. In this case, the inkjet recording apparatus 10 includes four ink supply portions 4.

### [Printing Portion 3]

The printing portion 3 ejects inks onto the sheet 9 conveyed by the belt conveyor device 23, thereby forming an image on the sheet 9.

The printing portion 3 includes a plurality of nozzle units 30 corresponding to the plurality of ink colors. The plurality of ink supply portions 4 supply the inks to the plurality of nozzle units 30.

In the present embodiment, the printing portion 3 includes four nozzle units 30 corresponding to black, cyan, magenta, and yellow inks.

Each of the nozzle units 30 has an ink ejection portion 31 (see FIG. 1). The ink ejection portion 31 includes a plurality of nozzles 32 disposed to face the upper surface of the conveying belt 231 (see FIG. 2). The plurality of nozzles 32 ejects ink onto the sheet 9 to form an image on the sheet 9.

The ink ejection portion 31 further includes a plurality of piezoelectric elements 33, a plurality of pressure chambers 35, and a plurality of vibration plates 34. The plurality of piezoelectric elements 33, the plurality of pressure chambers 35, and the plurality of vibration plates 34 are provided corresponding to the plurality of nozzles 32.

The plurality of pressure chambers 35 communicate with the plurality of nozzles 32, respectively. The plurality of pressure chambers 35 form passages for ink supplied to the plurality of nozzles 32, respectively. The ink in the plurality of pressure chambers 35 is supplied to the plurality of nozzles 32, respectively.

The plurality of vibration plates 34 form parts of partition walls of the plurality of pressure chambers 35, respectively. Each of the piezoelectric elements 33 is supplied with a drive signal to pressurize the ink in the pressure chamber 35 through the corresponding vibration plate 34.

The drive signal is a signal whose waveform is adjusted in accordance with the size of the ink droplets to be ejected. The drive signal is supplied from the control device 8 to each of the piezoelectric elements 33.

That is, each of the piezoelectric elements 33 pressurizes the ink supplied to the corresponding nozzle 32 by being supplied with the drive signal from the control device 8.

The piezoelectric element 33 supplied with the drive signal vibrates with the energy of ink ejected from the corresponding nozzle 32. That is, by being supplied with the drive signal, each of the piezoelectric elements 33 pressurizes the ink in the pressure chamber 35 to such an extent that the ink is ejected from the nozzle 32.

The ink pressurized by the piezoelectric element 33 supplied with the drive signal flows from the pressure chamber 35 into the corresponding nozzle 32 and is ejected from the nozzle 32.

That is, when the plurality of piezoelectric elements 33 pressurize inks supplied to the plurality of nozzles 32, causing the plurality of nozzles 32 to eject inks. The nozzle units 30 eject inks onto the sheet 9 conveyed on the conveying belt 231, thereby executing the printing process.

Each of the nozzle units 30 further includes a unit heater 36 and a unit temperature sensor 37 (see FIG. 2). The unit heater 36 and the unit temperature sensor 37 are disposed on the ink ejection portion 31 of each of the nozzle units 30.

That is, the inkjet recording apparatus 10 includes a plurality of unit heaters 36 and a plurality of unit temperature sensors 37 corresponding to the plurality of nozzle units 30.

The unit heater 36 heats the ink ejection portion 31. The unit temperature sensor 37 detects the temperature of the ink ejection portion 31. That is, the unit temperature sensor 37 detects the temperature of the nozzle unit 30 on the nozzle unit 30. For example, the unit temperature sensor 37 is a thermistor.

The unit temperature sensor 37 is an example of the internal temperature sensor that detects the internal temperature of the inkjet recording apparatus 10.

When the temperature of the ink decreases, the viscosity of the ink increases. When the viscosity of the ink supplied to each of the nozzles 32 is high, the performance of ejection of the ink from the nozzle 32 when the corresponding piezoelectric element 33 operates deteriorates.

The unit heater 36 maintains the viscosity of the ink supplied to each of the nozzles 32 in an appropriate state by heating the ink in the ink ejection portion 31.

Before the printing process is started, the unit heater 36 heats the ink in the ink ejection portion 31, thereby shortening the first print time. The first print time is a time from when the inkjet recording apparatus 10 receives a print request to when the printing process is started.

The power supply to the unit heater 36 is adjusted by feedback control based on the temperature detected by the unit temperature sensor 37.

The operation device 801 receives human operations. For example, the operation device 801 includes one or both of a touch panel and one or more push buttons. The display device 802 can display various types of information. For example, the display device 802 is a panel display device such as a liquid crystal panel unit.

### [Control Device 8]

The control device 8 executes various types of data processing and control of devices included in the inkjet recording apparatus 10.

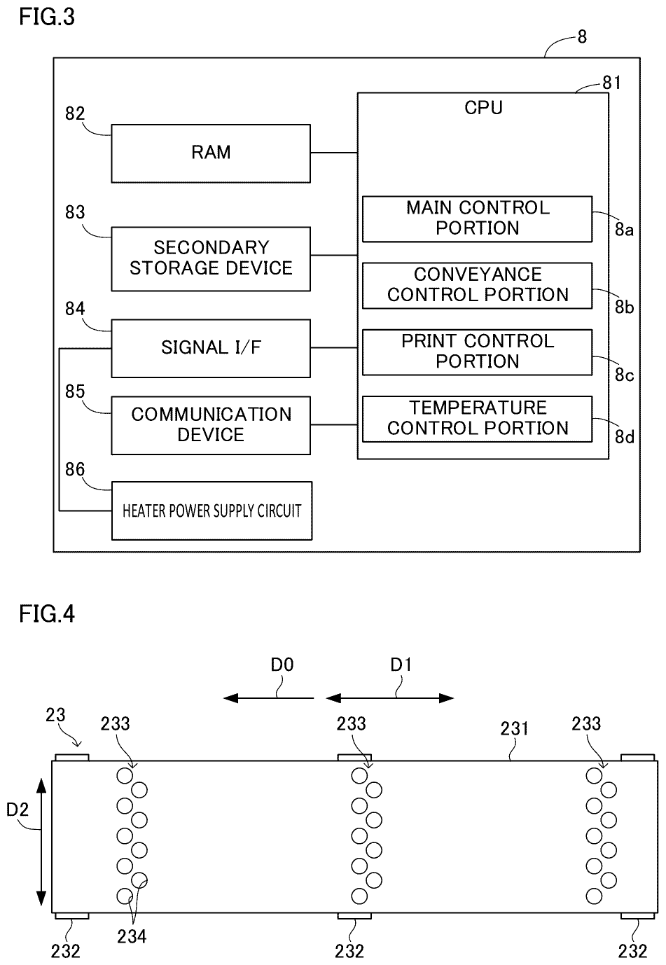

As shown in FIG. 3, the control device 8 includes a central processing unit (CPU) 81, a random access memory (RAM) 82, and peripheral devices such as a secondary storage device 83 and a signal interface 84. Further, the control device 8 includes a communication device 85 and a heater power supply circuit 86.

The CPU 81 is a processor that executes various types of data processing and control by executing computer programs. The CPU 81 is an example of the processor that controls the plurality of piezoelectric elements 33 and other devices.

The RAM 82 is a computer-readable volatile storage device. The RAM 82 temporarily stores the computer programs executed by the CPU 81 and data output and referred to while the CPU 81 is executing various types of processing.

The secondary storage device 83 is a computer-readable nonvolatile storage device. The secondary storage device 83 can store and update the computer programs and various types of data. For example, one or both of a flash memory and a hard disk drive are employed as the secondary storage device 83.

The signal interface 84 converts signals output from various sensors into digital data, and transmits the converted digital data to the CPU 81. Further, the signal interface 84 converts the control command output from the CPU 81 into a control signal, and transmits the control signal to the device to be controlled.

The communication device 85 can communicate with a host device (not shown) and other devices. The host device is an information processing device such as a personal computer or a smartphone operated by the user.

For example, the CPU 81 receives a print job from the host device through the communication device 85. The printing portion 3 forms an image specified by the print job on the sheet 9.

The heater power supply circuit 86 supplies an amount of power corresponding to an input power command to the unit heater 36.

The CPU 81 includes a plurality of processing modules implemented by executing the computer programs. The plurality of processing modules include a main control portion 8a, a conveyance control portion 8b, a print control portion 8c, a temperature control portion 8d, and the like.

The main control portion 8a executes control for starting various processes, control of the display device 802, and the like in response to processing requests input through the operation device 801 or the communication device 85. The processing requests include a print request for requesting execution of the printing process.

The conveyance control portion 8b controls the sheet conveying device 2. That is, the conveyance control portion 8b controls the supply of the sheet 9 by the feeding mechanism 21, the conveyance of the sheet 9 by the plurality of conveying roller pairs 22 and the belt conveyor device 23, and the discharge of the sheet 9 by the discharge roller pair 24.

The print control portion 8c causes the printing portion 3 to execute the printing process in synchronization with the conveyance of the sheet 9 by the sheet conveying device 2. The print control portion 8c controls the plurality of piezoelectric elements 33 to cause the printing portion 3 to execute the printing process.

The temperature control portion 8d controls the power supply to the unit heater 36 by outputting the power command signal to the heater power supply circuit 86 through the signal interface 84.

The nozzle units 30 include drive circuits 300 for supplying drive signals to the piezoelectric elements 33, respectively (see FIG. 1).

The drive circuit 300 outputs the drive signal to the corresponding piezoelectric element 33 in accordance with an input pressure command signal. Each of the nozzle units 30 forms an image on the sheet 9 by the ink ejected from the plurality of nozzles 32 by supplying the drive signals from the drive circuits 300 to the plurality of piezoelectric elements 33.

The print control portion 8c outputs a pressure command signal corresponding to the size of the ink droplets to be ejected from each of the nozzles 32 to the drive circuit 300 through the signal interface 84. The print control portion 8c controls each of the piezoelectric elements 33 through the drive circuit 300.

By the way, during the period from the occurrence of the print request to the end of the printing process, it is required to appropriately maintain the viscosity of the ink supplied to each of the nozzles 32 to prevent clogging of each of the nozzles 32.

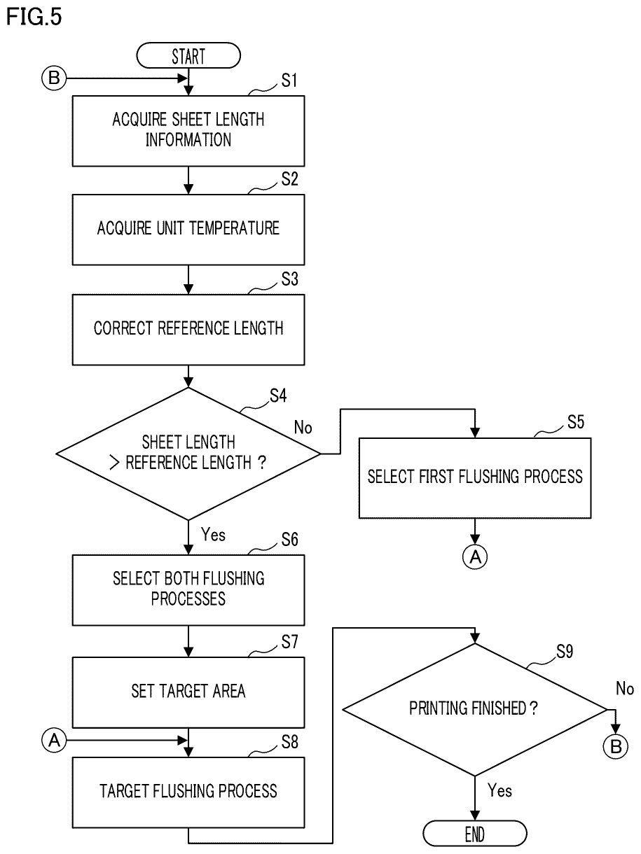

The print control portion 8c executes flushing control to be described later (see FIG. 5). The flushing control includes a process for preventing the clogging of each of the nozzles 32 during the period from the occurrence of the print request to the end of the printing process.

The conveying belt 231 of the belt conveyor device 23 has a plurality of openings 233, each consisting of one or more through holes 234, formed at intervals in the circumferential direction (see FIG. 4).

When the plurality of nozzles 32 eject ink when each of the opening 233 passes through the position facing the ink ejection portion 31 of each of the nozzle units 30, the ejected ink passes through the opening 233.

The inkjet recording apparatus 10 further includes an ink collection mechanism 5 for collecting ink that has passed through each of the openings 233 of the conveying belt 231 (see FIG. 1).

For example, the ink collection mechanism 5 includes an ink tray, a pump, an ink tank, and the like. The ink tray receives ink that has passed through each of the openings 233. The pump conveys the ink that has dropped on the ink tray by sucking the ink through a tube. The ink tank stores the ink conveyed by the pump.

The inkjet recording apparatus 10 further includes a belt position sensor 6 used to detect the rotational position of the conveying belt 231. For example, the belt position sensor 6 is a photosensor or a microswitch for detecting a detection target portion 230 formed on the conveying belt 231. The photosensor is a reflective or transmissive sensor.

When the belt position sensor 6 is the photosensor, the detection target portion 230 is a through hole, a mirror surface portion, or the like formed on the conveying belt 231. When the belt position sensor 6 is the microswitch, the detection target portion 230 is a projection or the like formed on the conveying belt 231.

The conveyance control portion 8b measures a belt rotation time, which is the rotation time of the conveying belt 231, starting from the point in time when the detection target portion 230 is detected by the belt position sensor 6.

Further, the conveyance control portion 8b identifies a base end passage timing in accordance with the belt rotation time.

The base end passage timing is a timing at which each of the openings 233 passes a base end of an area of the conveying belt 231 where the sheet 9 is conveyed. The base end is a start position of the conveyance of the sheet 9 on the conveying belt 231.

The conveyance control portion 8b controls the conveyance of the sheet 9 to the belt conveyor device 23 so that the leading end of the sheet 9 reaches the base end on the conveying belt 231 following the base end passage timing. The print control portion 8c controls the conveyance of the sheet 9 to the belt conveyor device 23 by controlling the preceding conveying device 22x.

The print control portion 8c identifies a nozzle passage timing in accordance with the belt rotation time. The nozzle passage timing is a timing at which each of the openings 233 passes through the position facing the ink ejection portion 31 of each of the nozzle units 30.

Here, one or more of the plurality of nozzle units 30 that face any of the plurality of openings 233 at the nozzle passage timing is referred to as a target nozzle unit. The print control portion 8c causes the target nozzle unit to execute a first flushing process at the nozzle passage timing.

The first flushing process is a process of ejecting ink toward each of the openings 233 in the area of the conveying belt 231 where the sheet 9 does not exist. The first flushing process is referred to as a line flushing process, for example.

Further, the print control portion 8c can cause each of the nozzle units 30 to execute a second flushing process while the sheet 9 is being conveyed by the belt conveyor device 23.

The second flushing process is a process of ejecting ink onto a non-drawing area of the sheet 9 in parallel with the printing process on the sheet 9. The second flushing process is referred to as, for example, in-sheet flushing process or in-page flushing process.

The print control portion 8c causes each of the nozzle units 30 to execute the second flushing process so that a plurality of ink dots are dispersed over a wide range of the sheet 9. Thus, the plurality of ink dots are formed on the sheet 9 as inconspicuous as possible.

By executing the first flushing process or the second flushing process, highly viscous ink is ejected from the plurality of nozzles 32 of each nozzle unit 30, and ink is newly filled. As a result, the viscosity of the ink in the plurality of nozzles 32 is appropriately maintained.

It is noted that the inkjet recording apparatus 10 may include a rotary encoder for detecting the rotational position of one of the plurality of tension rollers 232. In this case, the conveyance control portion 8b counts the number of encoder pulses, which is the number of output pulses of the rotary encoder, starting from the point in time when the detection target portion 230 is detected by the belt position sensor 6.

The conveyance control portion 8b can identify the base end passage timing in accordance with the number of encoder pulses. Similarly, the print control portion 8c can identify the nozzle passage timing in accordance with the number of encoder pulses.

### [Flushing Control]

An example of the procedure of the flushing control will be described below with reference to the flowchart shown in FIG. 5.

When receiving the print request through the operation device 801 or the communication device 85, the main control portion 8a causes the print control portion 8c to execute the flushing control.

The flushing control is an example of processing for implementing the inkjet control method for controlling the inkjet recording apparatus 10. The CPU 81, which includes the print control portion 8c, is an example of the processor that implements the inkjet control method.

In the following description, S1, S2, . . . represent identification codes of a plurality of steps in the flushing control. In the flushing control, the process of step S1 is executed first.

### <Step S1>

In step S1, the print control portion 8c acquires sheet length information representing the length in the conveying direction DO of a target sheet, which is the sheet 9 to be conveyed by the belt conveyor device 23.

For example, the print control portion 8c acquires sheet information included in the print request as the sheet length information. The sheet information includes sheet size information representing the vertical size and the horizontal size of the target sheet, and orientation information representing the orientation of the target sheet. The size information may be information representing the standard size of the sheet 9.

In the above case, the print control portion 8c identifies one of the vertical size information and the horizontal size information of the target sheet as the sheet length information in accordance with the orientation information.

The print control portion 8c executes the process of step S2 after executing the process of step S1.

### <Step S2>

In step S2, the print control portion 8c acquires a unit temperature, which is a temperature detected by the unit temperature sensor 37 of each of the nozzle units 30.

The print control portion 8c executes the process of step S3 after executing the process of step S2.

### <Step S3>

In step S3, the print control portion 8c corrects a preset reference length based on the unit temperature.

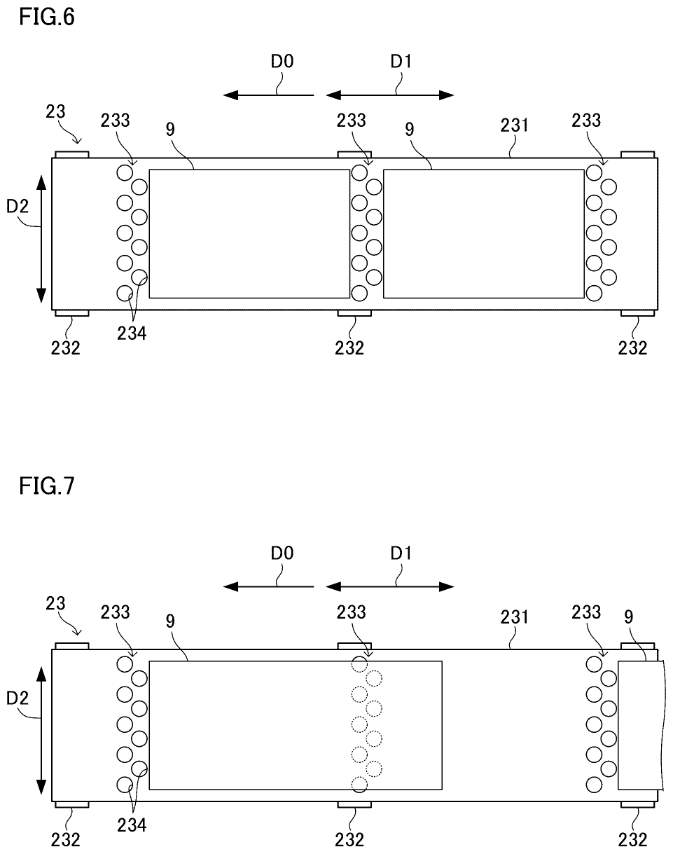

The reference length is a length to be compared with the length of the sheet length information. For example, the reference length before correction is approximately the interval between the plurality of openings 233 in the conveying belt 231. FIG. 6 shows how the sheet 9 of the reference length before correction is conveyed by the belt conveyor device 23. FIG. 7 shows a state in which a sheet 9 longer than the reference length before correction is conveyed by the belt conveyor device 23.

When the sheet 9 of the reference length before correction is conveyed in a state where the unit temperature is the reference temperature, the viscosity of the ink in the plurality of nozzles 32 is appropriately maintained only by the first flushing process.

When the unit temperature is higher than a reference temperature range based on the reference temperature, the print control portion 8c corrects the reference length to be longer. On the other hand, when the unit temperature is lower than the reference temperature range, the print control portion 8c sets the reference length to 0.

The print control portion 8c executes the process of step S4 after executing the process of step S3.

It is noted that the inkjet recording apparatus 10 may be provided with a peripheral temperature sensor for detecting a temperature around the plurality of nozzle units 30. In this case, the detected temperature of the peripheral temperature sensor may be used to correct the reference length instead of the unit temperature. The peripheral temperature sensor is an example of the internal temperature sensor.

### <Step S4>

In step S4, the print control portion 8c compares the length of the sheet length information with the reference length. The print control portion 8c selects the next process depending on whether or not the length of the sheet length information is longer than the reference length.

When the length of the sheet length information is not longer than the reference length, the print control portion 8c executes the process of step S5. On the other hand, when the length of the sheet length information is longer than the reference length, the print control portion 8c executes the process of step S6.

### <Step S5>

In step S5, the print control portion 8c selects the first flushing process as the target flushing process among the first flushing process and the second flushing process.

As will be described later, the target flushing process is a process executed when the target sheet is conveyed. The print control portion 8c executes the process of step S8 after executing the process of step S5.

### <Step S6>

In step S6, the print control portion 8c selects both the first flushing process and the second flushing process as the target flushing process.

The print control portion 8c executes the process of step S7 after executing the process of step S6.

It is noted that it is conceivable that only the second flushing process is selected as the target flushing process in step S6.

That is, in steps S4 to S6, the print control portion 8c selects one or both of the first flushing process and the second flushing process as the target flushing process in accordance with the sheet length information.

### <Step S7>

In step S7, the print control portion 8c sets a target area to be subjected to the second flushing process in the entire area of the target sheet in the conveying direction DO in accordance with the sheet length information.

The target area is a continuous area extending from the tailing end to the leading end of the target sheet. The target area is a partial area or an entire area of the target sheet.

For example, the print control portion 8c sets the target area that is longer in the conveying direction DO when the length of the sheet length information is long than when it is short.

The process of step S7 is executed when the target flushing process including the second flushing process is selected. The print control portion 8c executes the process of step S8 after executing the process of step S7.

### <Step S8>

In step S8, the print control portion 8c causes each of the nozzle units 30 to execute the target flushing process selected in step S5 or step S6.

The print control portion 8c causes each of the nozzle units 30 to execute the target flushing process in parallel with the printing process corresponding to the print request.

When the target flushing process includes the first flushing process, the print control portion 8c causes each of the nozzle units 30 to execute the first flushing process directed at at least one of the plurality of openings 233 that is located closest to the leading end of the target sheet.

When the target flushing process includes the second flushing process, the print control portion 8c causes each of the nozzle units 30 to execute the second flushing process directed at the target area of the target sheet.

The print control portion 8c executes the process of step S9 after executing the process of step S8.

### <Step S9>

In step S9, the print control portion 8c selects the next process depending on whether or not the printing process corresponding to the print request has finished.

When the printing process corresponding to the print request has finished, the print control portion 8c executes the process of step S1 and subsequent steps for the next target sheet. On the other hand, the print control portion 8c terminates the flushing control when the printing process corresponding to the print request has finished.

By the flushing control being executed, the viscosity of the ink supplied to each of the nozzles 32 of each of the nozzle units 30 is appropriately maintained during the period from the occurrence of the print request to the end of the printing process. As a result, clogging of each of the nozzles 32 is prevented.

### [First Modification]

Next, a first modification of the inkjet recording apparatus 10 will be described.

In the present modification, the inkjet recording apparatus 10 includes a humidity sensor for detecting the humidity in the main housing 11. The humidity sensor is an example of the internal humidity sensor that detects the internal temperature of the inkjet recording apparatus 10.

In step S2 of the flushing control, the print control portion 8c in the present modification acquires an environmental humidity which is the humidity detected by the humidity sensor.

Further, in step S3 of the flushing control, the print control portion 8c in the present modification corrects the reference length in accordance with the environmental humidity.

For example, when the environmental humidity is higher than a reference humidity range based on the reference humidity, the print control portion 8c in the present modification corrects the reference length to be longer. On the other hand, when the environmental humidity is lower than the reference humidity range, the print control portion 8c sets the reference length to 0.

In the present modification, the print control portion 8c may execute both the correction based on the unit temperature and the correction based on the environmental humidity with respect to the correction of the reference length. In addition, the print control portion 8c may execute only one of the correction based on the unit temperature and the correction based on the environmental humidity with respect to the correction of the reference length.

### [Second Modification]

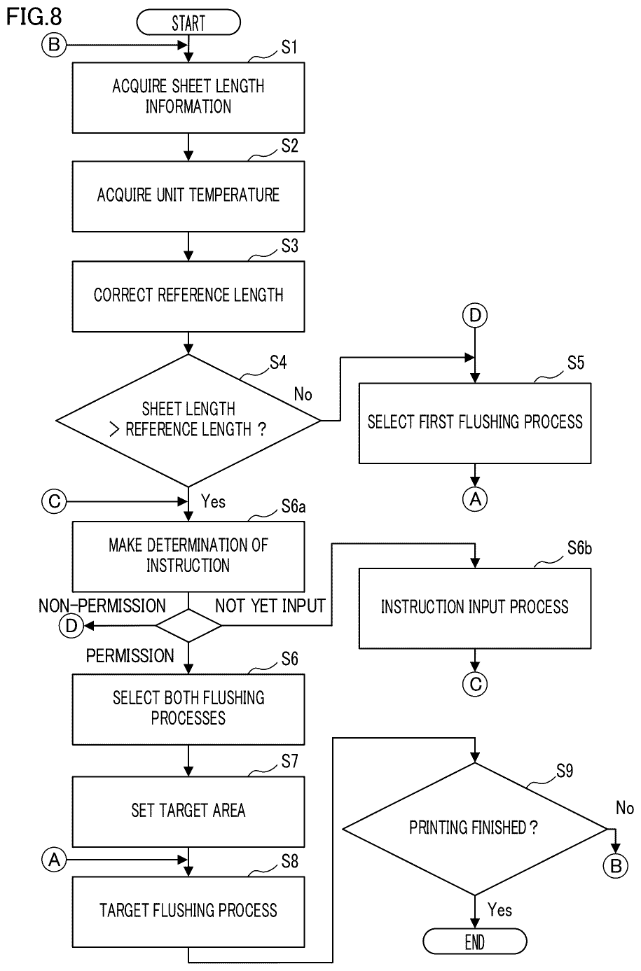

Next, a second modification of the inkjet recording apparatus 10 will be described with reference to the flowchart shown in FIG. 8.

In the present modification, the main control portion 8a can set one of two candidate modes as the operation mode in accordance with mode setting information input through the operation device 801 or the communication device 85.

The two candidate modes include a first operation mode in which one or both of the first flushing process and the second flushing process are automatically selected as the target flushing process, and a second operation mode in which only the first flushing process is preferentially selected as the target flushing process.

In the present modification, when the first operation mode is set as the operation mode, the print control portion 8c executes the flushing control in accordance with the procedure shown in FIG. 5.

On the other hand, when the second operation mode is set as the operation mode, the print control portion 8c sets a preset upper limit length as the reference length, and then executes the flushing control in accordance with the procedure shown in FIG. 8.

The print control portion 8c in the present application example executes the flushing control in accordance with the procedure in which step S6a and step S6b are added to the procedure shown in FIG. 5.

The processes of steps S1 to S5 shown in FIG. 8 are the same as the processes of steps S1 to S5 shown in FIG. 5. The differences in the procedure shown in FIG. 8 from the procedure shown in FIG. 5 will be described below.

### <Step S4>

In step S4, when the length of the sheet length information is longer than the reference length, the print control portion 8c executes the process of step S6a.

### <Step S6a>

In step S6a, the print control portion 8c determines the input status of an instruction corresponding to the second operation mode.

The instruction is input by the process of step S6b to be described later, and represents permission or non-permission of the execution of the second flushing process.

The print control portion 8c executes the process of step S6b when the instruction has not been input yet.

When the target sheet is the first sheet 9 in the printing process corresponding to the print request, the print control portion 8c executes the process of step S6b before starting the printing process.

On the other hand, when the target sheet is the second or subsequent sheet 9 in the printing process corresponding to the print request, the print control portion 8c interrupts the printing process and executes the process of step S6b.

In addition, the print control portion 8c executes the process of step S6 when the instruction representing the permission has been input. In this case, the print control portion 8c executes the same process as in the case where the first operation mode is set.

On the other hand, the print control portion 8c executes the process of step S5 when the instruction representing the non-permission has been input. As described above, in step S5, the first flushing process is selected as the target flushing process.

That is, when the instruction representing the non-permission has been inputted, the print control portion 8c selects only the first flushing process as the target flushing process regardless of the content of the sheet length information.

### <Step S6b>

In step S6b, the print control portion 8c executes a process of inputting the instruction.

In step S6b, the print control portion 8c notifies a predetermined message through the display device 802 or the communication device 85. For example, the message includes information that the length of the target sheet is a length that requires the second flushing process. In addition, the message may include information that the non-permission of the second flushing process may adversely affect output image quality.

Further, in step S6b, the print control portion 8c inputs either the permission information or the non-permission information about the second flushing process through the operation device 801 or the communication device 85.

After executing the process of step S6b, the print control portion 8c executes the process of step S6a and subsequent processes again.

By employing the present application example, the flushing control reflecting the intention of the user is executed. It is noted that the present application example may be applied to the first application example.

### [Appendixes of Invention]

The following are appendixes to the overview of the invention extracted from the above embodiment. It is noted that the structures and processing functions to be described in the following appendixes can be selected and combined arbitrarily.

### <Appendix 1>

An inkjet control method for controlling an inkjet recording apparatus comprising:
a belt conveyor device including an endless conveying belt in which a plurality of opening portions, each including one or more through holes, are formed at intervals in a circumferential direction and configured to convey a sheet on the conveying belt by rotating the conveying belt; and
a nozzle unit including a plurality of nozzles disposed to face an upper surface of the conveying belt and a plurality of piezoelectric elements configured to cause the plurality of nozzles to eject ink by pressurizing ink supplied to the plurality of nozzles, and capable of executing a printing process of forming an image on the sheet by ejecting ink onto the sheet conveyed on the conveying belt, the inkjet control method comprising:
a processor acquiring sheet length information representing a length in a conveying direction of a target sheet to be conveyed by the belt conveyor device; and
the processor selecting, as a target flushing process, one or both of a first flushing process in which ink is ejected toward each of the plurality of opening portions in an area of the conveying belt where the sheet does not exist and a second flushing process in which ink is ejected toward a non-drawing area of the target sheet in parallel with the printing process on the target sheet, in accordance with the sheet length information, and causing the nozzle unit to execute the target flushing process.

### <Appendix 2>

The inkjet control method according to Appendix 1, wherein
when the inkjet recording apparatus includes one or both of an internal temperature sensor configured to detect an internal temperature and an internal humidity sensor configured to detect an internal humidity,
the processor corrects a reference length in accordance with a detection result of one or both of the internal temperature sensor and the internal humidity sensor, and selects the target flushing process by comparing the length represented by the sheet length information with the corrected reference length.

### <Appendix 3>

The inkjet control method according to Appendix 2, wherein
when the inkjet recording apparatus includes a heater configured to heat the nozzle unit and a unit temperature sensor configured to detect a temperature of the nozzle unit,
the processor corrects the reference length using the temperature detected by the unit temperature sensor as the temperature detected by the internal temperature sensor.

### <Appendix 4>

The inkjet control method according to any one of Appendixes 1 to 3, wherein, when selecting the target flushing process including the second flushing process, the processor sets a target area to be subject to the second flushing process among all areas of the target sheet in the conveying direction in accordance with the sheet length information.

### <Appendix 5>

An inkjet recording apparatus comprising:
a belt conveyor device including an endless conveying belt in which a plurality of opening portions, each including one or more through holes, are formed at intervals in a circumferential direction and configured to convey a sheet on the conveying belt by rotating the conveying belt;
a nozzle unit including a plurality of nozzles disposed to face an upper surface of the conveying belt and a plurality of piezoelectric elements configured to cause the plurality of nozzles to eject ink by pressurizing ink supplied to the plurality of nozzles, and capable of executing a printing process of forming an image on the sheet by ejecting ink onto the sheet conveyed on the conveying belt; and
a processor configured to implement the inkjet control method according to any one of Appendixes 1 to 4.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An inkjet control method for controlling an inkjet recording apparatus comprising:
a belt conveyor device including an endless conveying belt in which a plurality of opening portions, each including one or more through holes, are formed at intervals in a circumferential direction and configured to convey a sheet on the conveying belt by rotating the conveying belt; and
a nozzle unit including a plurality of nozzles disposed to face an upper surface of the conveying belt and a plurality of piezoelectric elements configured to cause the plurality of nozzles to eject ink by pressurizing ink supplied to the plurality of nozzles, and capable of executing a printing process of forming an image on the sheet by ejecting ink onto the sheet conveyed on the conveying belt, the inkjet control method comprising:
a processor acquiring sheet length information representing a length in a conveying direction of a target sheet to be conveyed by the belt conveyor device; and
the processor selecting, as a target flushing process, one or both of a first flushing process in which ink is ejected toward each of the plurality of opening portions in an area of the conveying belt where the sheet does not exist and a second flushing process in which ink is ejected toward a non-drawing area of the target sheet in parallel with the printing process on the target sheet, in accordance with the sheet length information, and causing the nozzle unit to execute the target flushing process.

2. The inkjet control method according to claim 1, wherein
when the inkjet recording apparatus includes one or both of an internal temperature sensor configured to detect an internal temperature and an internal humidity sensor configured to detect an internal humidity,
the processor corrects a reference length in accordance with a detection result of one or both of the internal temperature sensor and the internal humidity sensor, and selects the target flushing process by comparing the length represented by the sheet length information with the corrected reference length.

3. The inkjet control method according to claim 2, wherein
when the inkjet recording apparatus includes a heater configured to heat the nozzle unit and a unit temperature sensor configured to detect a temperature of the nozzle unit,
the processor corrects the reference length using the temperature detected by the unit temperature sensor as the temperature detected by the internal temperature sensor.

4. The inkjet control method according to claim 1, wherein, when selecting the target flushing process including the second flushing process, the processor sets a target area to be subject to the second flushing process among all areas of the target sheet in the conveying direction in accordance with the sheet length information.

5. An inkjet recording apparatus comprising:
a belt conveyor device including an endless conveying belt in which a plurality of opening portions, each including one or more through holes, are formed at intervals in a circumferential direction and configured to convey a sheet on the conveying belt by rotating the conveying belt;
a nozzle unit including a plurality of nozzles disposed to face an upper surface of the conveying belt and a plurality of piezoelectric elements configured to cause the plurality of nozzles to eject ink by pressurizing ink supplied to the plurality of nozzles, and capable of executing a printing process of forming an image on the sheet by ejecting ink onto the sheet conveyed on the conveying belt; and
a processor configured to implement the inkjet control method according to claim 1.
